(19) United States
(12) Patent Application Publication
(10) Pub. No.: US 2019/0161259 A1
(43) Pub. Date: May 30, 2019

(54) PACKAGING METHOD BASED ON A SEMI-CRYSTALLINE THERMOPLASTIC POLYESTER

(71) Applicant: ROQUETTE FRERES, Lestrem (FR)

(72) Inventors: Hélène AMEDRO, BETHUNE (FR); René SAINT-LOUP, LOMME (FR)

(21) Appl. No.: 16/321,949

(22) PCT Filed: Aug. 3, 2017
(86) PCT No.: PCT/FR2017/052176

§ 371 Date: Jan. 30, 2019

(30) Foreign Application Priority Data
Aug. 3, 2016 (FR) 16 57546

(51) Int. Cl. B65D 75/00; C08J 5/18; C08G 63/672

(52) U.S. Cl. CPC B65D 75/002; C08J 5/18; C08G 63/183; C08J 2367/02; C08G 63/672

(57) ABSTRACT

Packaging method comprising the following steps: (a) providing a semi-crystalline thermoplastic polyester having at least one 1,4:3,6-dianhydrohexitol unit (A), at least one alicyclic diol unit (B) other than the 1,4:3,6-dianhydrohexitol units (A), and at least one terephthalic acid unit (C), wherein the molar ratio (A)/[(A)+(B)] is at least 0.05 and at most 0.30, said polyester being free of non-cyclic aliphatic diol units or comprising a molar amount of non-cyclic aliphatic diol units, relative to the totality of monomeric units in the polyester, of less than 5%, and with a reduced viscosity in solution (25° C.; phenol (50 wt. %): ortho-dichlorobenzene (50 wt. %); 5 g/L of polyester) greater than 50 mL/g; (b) preparing a heat-shrinkable film from the semi-crystalline thermoplastic polyester obtained in step (a); (c) covering a product with the heat-shrinkable film obtained in step (b); (d) applying a heat treatment to the packaged product.

### FIELD OF THE INVENTION

The present invention relates to the packaging field and in particular to a packaging process using heat-shrinkable films produced from a semicrystalline thermoplastic polyester comprising at least one 1,4:3,6-dianhydrohexitol unit.

### TECHNICAL BACKGROUND OF THE INVENTION

Plastics have become inescapable in the mass production of objects. Indeed, their thermoplastic character enables these materials to be transformed at a high rate into all kinds of objects.

Certain thermoplastic aromatic polyesters have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units, used for example in the production of films.

However, for certain applications or under certain usage conditions, it is necessary to improve certain properties, especially impact strength or else heat resistance. This is why glycol-modified PETs (PETgs) have been developed. They are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties.

Other modified PETs have also been developed by introducing, into the polyester, 1,4:3,6-dianhydrohexitol units, especially isosorbide (PEITs). These modified polyesters have higher glass transition temperatures than the unmodified PETs or PETgs comprising CHDM. In addition, 1,4:3,6-dianhydrohexitols have the advantage of being able to be obtained from renewable resources such as starch.

One problem with these PEITs is that they may have inadequate impact strength properties. In addition, the glass transition temperature may be inadequate for the production of certain plastic objects.

In order to improve the impact strength properties of the polyesters, it is known from the prior art to use polyesters in which the crystallinity has been reduced. As regards isosorbide-based polyesters, mention may be made of application US2012/0177854, which describes polyesters comprising terephthalic acid units and diol units comprising from 1 to 60 mol % of isosorbide and from 5 to 99% of 1,4-cyclohexanedimethanol which have improved impact strength properties. As indicated in the introductory section of this application, the aim is to obtain polymers in which the crystallinity is eliminated by the addition of comonomers, and hence in this case by the addition of 1,4-cyclohexanedimethanol. In the examples section, the production of various poly(ethylene-co-1,4-cyclohexanedimethylene-co-isosorbide)terephthalates (PECITs), and also an example of poly(1,4-cyclohexanedimethylene-co-isosorbide)terephthalate (PCIT), are described.

It may also be noted that while polymers of PECIT type have been the subject of commercial developments, this is not the case for PCITs. Indeed, their production was hitherto considered to be complex, since isosorbide has low reactivity as a secondary diol. Yoon et al. (Synthesis and Characteristics of a Biobased High-Tg Terpolyester of Isosorbide, Ethylene Glycol, and 1,4-Cyclohexane Dimethanol: Effect of Ethylene Glycol as a Chain Linker on Polymerization, Macromolecules, 2013, 46, 7219-7231) thus showed that the synthesis of PCIT is much more difficult to achieve than that of PECIT. This paper describes the study of the influence of the ethylene glycol content on the PECIT production kinetics.

In Yoon et al., an amorphous PCIT (which comprises approximately 29% isosorbide and 71% CHDM, relative to the sum of the diols) is produced to compare its synthesis and its properties with those of PECIT-type polymers. The use of high temperatures during the synthesis induces thermal degradation of the polymer formed if reference is made to the first paragraph of the Synthesis section on page 7222, this degradation especially being linked to the presence of aliphatic cyclic diols such as isosorbide.

Therefore, Yoon et al. used a process in which the polycondensation temperature is limited to 270° C. Yoon et al. observed that, even increasing the polymerization time, the process also does not make it possible to obtain a polyester having a sufficient viscosity. Thus, without addition of ethylene glycol, the viscosity of the polyester remains limited, despite the use of prolonged synthesis times.

Thus, despite the modifications made to the PETs, there is still a constant need for novel polyesters having improved properties.

Objects produced from polymers having terephthalic acid units, ethylene glycol units and isosorbide units and optionally another diol (for example 1,4-cyclohexanedimethanol) are known from document U.S. Pat. No. 6,126,992. All the polymers obtained thus have ethylene glycol units, since it is widely accepted that they are necessary for the incorporation of the isosorbide and for obtaining a high glass transition temperature. Furthermore, the preparation examples implemented do not make it possible to obtain from the polymers a unit composition able to be entirely satisfactory in the production of heat-shrinkable films. Indeed, example 1 describes in particular the preparation of a polymer comprising 33.5% of ethylene glycol unit and 12.9% of isosorbide unit, i.e. an isosorbide unit/ethylene glycol unit ratio of 0.39, which is implausible, even apart from the fact that the polymer contains ethylene glycol, for the production of heat-shrinkable films.

Document U.S. Pat. No. 5,958,581 describes polyester films produced from a polymer having isosorbide units, terephthalic acid units and ethylene glycol units. The films thus produced are suitable for use in particular as food packaging or as insulating material.

The use of heat-shrinkable films is well known to the packaging industry, said films often being used to package a multitude of products, in particular food products.

For example, the products to be packaged may be placed in a bag produced from heat-shrinkable films, then, after the application of heat treatment, the film shrinks, thus resulting in the packaging of said product. Such a bag generally consists of a single-layer polyester film. Heat-shrinkable films can also be used to keep several products together, for instance for obtaining product batches. When the film surrounds the batch of the product, the application of heat treatment brings about shrinking of the film which thus closely fits the shape of the batch and then hardens on cooling.

The polyesters used at the current time provide solutions for the production of a heat-shrinkable film and make it possible in particular to supply packagings which offer strength and protection by means of tight adhesion to the product. However, it remains necessary to have available new polyesters with improved properties which make it possible to obtain heat-shrinkable films that have better heat resistance and also improved mechanical properties such as yield strength and tear strength.

Document U.S. Pat. No. 4,971,845 describes heat-shrinkable laminated films which have a first layer made of heat-shrinkable thermoplastic material and a sealable second layer, and also describes bags or other packaging produced from these films. The first layer may be a polyester such as polyethylene terephthalate (PET) and the second layer may be a polyolefin such as polypropylene or polyethylene, the two layers having approximately the same heat-shrink properties. The films thus obtained exhibit a heat-shrinkage of approximately 50%.

Document U.S. Pat. No. 6,623,821 also describes heat-shrinkable films based on polyethylene terephthalate (PET) for packaging. The polyethylene terephthalate may be a PET homopolymer or copolymer. The PET homopolymer is a polymer which derives from polymerization between ethylene glycol and terephthalic acid. The films described may be covered with a layer of solvent allowing sealing by heat treatment or may be laminated to other films.

Although solutions exist, packaging is a constantly changing field for which it is necessary to constantly provide alternative solutions which have better properties compared with the solutions already present on the market.

Thus, there is always a need for heat-shrinkable films which have improved properties in order to obtain packagings that are ever more effective.

It is thus to the applicant's credit to have found that this object can, against all expectations, be achieved with a semicrystalline thermoplastic polyester based in particular on isosorbide and not having ethylene glycol, while it was hitherto known that the latter was essential for the incorporation of said isosorbide.

Indeed, by virtue of a particular viscosity and a particular ratio of units, the semicrystalline thermoplastic polyester used according to the present invention has improved properties for a use according to the invention in the production of heat-shrinkable films.

### SUMMARY OF THE INVENTION

A first subject of the invention relates to a packaging process comprising the following steps:
a) providing a semicrystalline thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] molar ratio is at least 0.05 and at most 0.30, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 g/I of polyester) of said polyester being greater than 50 ml/g,
b) preparing a heat-shrinkable film from the semicrystalline thermoplastic polyester obtained in step a),
c) covering a product by means of the heat-shrinkable film obtained in step b),
d) applying a heat treatment to said covered product.

A second subject of the invention relates to a packaging obtained from a heat-shrinkable film produced from the semicrystalline thermoplastic polyester as defined above.

The semicrystalline thermoplastic polyesters according to the invention offer excellent properties and make it possible in particular to obtain heat-shrinkable films which have better heat resistance and improved mechanical properties, said films being particularly suitable for the production of packaging.

### DETAILED DESCRIPTION OF THE INVENTION

A first subject of the invention relates to a process for packaging products using heat-shrinkable film produced from a semicrystalline thermoplastic polyester, comprising the following steps:
a) providing a semicrystalline thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)I[(A)+(B)] molar ratio is at least 0.05 and at most 0.30, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m):ortho-dichlorobenzene (50% m); 5 g/I of polyester) of said polyester being greater than 50 ml/g,
b) preparing a heat-shrinkable film from the semicrystalline thermoplastic polyester obtained in step a),
c) covering a product by means of the heat-shrinkable film obtained in step b),
d) applying a heat treatment to said packaged product.

“(A)/[(A)+(B)] molar ratio” is intended to mean the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A).

The semicrystalline thermoplastic polyester of the providing step a) is thus free of non-cyclic aliphatic diol units, or comprises a small amount thereof.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

The term “heat-shrinkable” denotes in particular the ability of a film to be oriented in a way which allows it to shrink in the direction of the length and in the transverse direction when it is subjected to heat stresses.

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

This molar amount of aliphatic non-cyclic diol unit is advantageously less than 1%. Preferably, the polyester is free of any aliphatic non-cyclic diol units and more preferentially it is free of ethylene glycol.

Despite the low amount of aliphatic non-cyclic diol, and hence of ethylene glycol, used for the synthesis, a semicrystalline thermoplastic polyester is surprisingly obtained which has a high reduced solution viscosity and in which the isosorbide is particularly well incorporated. Without being bound by any one theory, this would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The monomer (A) is a 1,4:3,6-dianhydrohexitol and may be isosorbide, isomannide, isoidide, or a mixture thereof. Preferably, the 1,4:3,6-dianhydrohexitol (A) is isosorbide. Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. The alicyclic dial (B) is very preferentially 1,4-cyclohexanedimethanol. The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic dial units (B) other than the 1,4:3,6-dianhydrohexitol units (A), i.e. (A)/[(A)+(B)], is at least 0.05 and at most 0.30. Advantageously, this ratio is at least 0.1 and at most 0.28, and more particularly this ratio is at least 0.15 and at most 0.25.

A semicrystalline thermoplastic polyester that is particularly suitable for the preparation of heat-shrinkable films comprises:
a molar amount of 1,4:3,6-dianhydrohexitol units (A) ranging from 2.5 to 14 mol %;
a molar amount of alicyclic diol units (B) other than the 1,4:3,6-dianhydrohexitol units (A) ranging from 31 to 42.5 mol %;
a molar amount of terephthalic acid units (C) ranging from 45 to 55 mol %.

The amounts of different units in the polyester may be determined by ¹H NMR or by chromatographic analysis of the mixture of monomers resulting from complete hydrolysis or methanolysis of the polyester, preferably by ¹H NMR.

Those skilled in the art can readily find the analysis conditions for determining the amounts of each of the units of the polyester. For example, from an NMR spectrum of a poly(1,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The semicrystalline thermoplastic polyesters used according to the invention for step b) of preparing heat-shrinkable films have a melting point ranging from 210 to 295° C., for example from 240 to 285° C.

Furthermore, the semicrystalline thermoplastic polyesters have a glass transition temperature ranging from 85 to 120° C., for example from 90 to 115° C. The glass transition temperature and melting point are measured by conventional methods, in particular using differential scanning calorimetry (DSC) using a heating rate of 10° C./min. The experimental protocol is described in detail in the examples section below.

Advantageously, the semicrystalline thermoplastic polyester has a heat of fusion of greater than 10 J/g, preferably greater than 20 J/g, the measurement of this heat of fusion consisting in subjecting a sample of this polyester to a heat treatment at 170° C. for 16 hours, then in evaluating the heat of fusion by DSC by heating the sample at 10° C./min.

The semicrystalline thermoplastic polyester used according to the invention for step b) of preparing heat-shrinkable films has in particular a lightness L* of greater than 40. Advantageously, the lightness L* is greater than 55, preferably greater than 60, most preferentially greater than 65, for example greater than 70. The parameter L* may be determined using a spectrophotometer, via the CIE Lab model.

Finally, the reduced solution viscosity of said semicrystalline thermoplastic polyester is greater than 50 ml/g and preferably less than 150 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/I.

This test for measuring reduced solution viscosity is, due to the choice of solvents and the concentration of the polymers used, perfectly suited to determining the viscosity of the viscous polymer prepared according to the process described below.

The semicrystalline nature of the thermoplastic polyesters used according to the present invention is distinguished when the latter, after a heat treatment of 16 h at 170° C., have X-ray diffraction lines or an endothermic melting peak in differential scanning calorimetry (DSC) analysis.

The semicrystalline thermoplastic polyester as previously defined has many advantages for the preparation of heat-shrinkable films.

Indeed, by virtue in particular of the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and at most 0.30 and of a reduced solution viscosity of greater than 50 ml/g and preferably less than 150 ml/g, the semicrystalline thermoplastic polyesters make it possible to prepare heat-shrinkable films which have better heat resistance and improved mechanical properties compared for example with conventional heat-shrinkable films produced from polyethylene isosorbide terephthalate (PEIT), which is particularly advantageous for obtaining packagings with improved properties.

The difference between a heat-shrinkable film and a sheet lies in the thickness as such. However, there is no industrial standard which precisely defines the thickness beyond which a sheet is considered to be a heat-shrinkable film. Thus, according to the present invention, a heat-shrinkable film is defined as having a thickness of less than 250 μm. Preferably, the heat-shrinkable films have a thickness of from 5 μm to 250 μm, preferentially from 10 μm to 250 μm, for example 50 μm.

The heat-shrinkable films prepared according to the invention may be directly prepared from the melted state after polymerization of the semicrystalline thermoplastic polyester provided in step a).

According to one alternative, the semicrystalline thermoplastic polyester may be packaged in a form that is easy to handle, such as pellets or granules, before being used for preparing heat-shrinkable films. Preferentially, the semicrystalline thermoplastic polyester is wrapped in the form of granules, said granules being advantageously dried before conversion into the form of heat-shrinkable films. The drying is carried out so as to obtain granules having a residual moisture content of less than 300 ppm, preferentially less than 200 ppm, for instance approximately 180 ppm.

The heat-shrinkable films prepared may be single-layer heat-shrinkable films or multilayer heat-shrinkable films obtained for example by laminating several layers, at least one of which contains a semicrystalline thermoplastic polyester according to the invention.

The heat-shrinkable films prepared from the semicrystalline thermoplastic polyester according to the invention can be obtained by the methods known to those skilled in the art, for instance flat-die extrusion or else annular-die extrusion (extrusion blow-molding). Preferentially, the heat-shrinkable films are prepared by the flat-die extrusion method.

The preparation of heat-shrinkable films via flat-die extrusion, termed “cast extrusion”, consists in stretching, along two axes, a flat sheet at the extruder outlet. Particularly advantageously, this extrusion is carried out by means of a Stenter process which makes it possible to obtain biaxially oriented films by sequential biaxial orientation.

The preparation of the heat-shrinkable films can also be carried out by extrusion blow-molding and thus consists in extruding the material through an annular die and in simultaneously stretching it in the two directions by the combined action of stretching and blow molding. The tubular sheaths thus obtained have a thickness between 10 and 300 μm and a perimeter which ranges from a few centimeters to more than 10 meters. The axis of extrusion may be vertical or horizontal, with balloon heights that can reach more than 20 meters.

According to this method, a thin sheath is extruded, clamped and blown with air which fills the sheath via the axis of the die head. A first radial stretching is thus carried out by blow-molding. The sheath is subsequently cooled, then stretched longitudinally by stretching rollers.

According to one particular embodiment, one or more additional polymers may be used for step b) of preparing the heat-shrinkable film.

The additional polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2,6-dimethylphenylene oxide), poly(phenylene sulfate)s, poly(ester-carbonate)s, polycarbonates, polysulfones, polysulfone ethers, polyether ketones, and blends of these polymers.

The additional polymer may also be a polymer which makes it possible to improve the impact properties of the polymer, especially functional polyolefins such as functionalized ethylene or propylene polymers and copolymers, core-shell copolymers or block copolymers.

One or more additives may also be added during the preparation of the heat-shrinkable film from the semicrystalline thermoplastic polyester in order to give it particular properties.

Thus, by way of examples of additives, mention may be made of fillers or fibers of organic or mineral, nanometric or non-nanometric, functionalized or non-functionalized nature. They may be silicas, zeolites, glass beads or fibers, clays, mica, titanates, silicates, graphite, calcium carbonate, carbon nanotubes, wood fibers, carbon fibers, polymer fibers, proteins, cellulose-based fibers, lignocellulosic fibers and non-destructured granular starch. These fillers or fibers can make it possible to improve the hardness, the rigidity or the water- or gas-permeability.

The additive may also be chosen from opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The additive may also be a UV-resistance agent such as, for example, molecules of benzophenone or benzotriazole type, such as the Tinuvin™ range from BASF: tinuvin 326, tinuvin P or tinuvin 234, for example, or hindered amines such as the Chimassorb™ range from BASF: Chimassorb 2020, Chimassorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example melapur™: melapur 200), or else aluminum or magnesium hydroxides.

Finally, the additive may also be an antistatic agent or else an anti-block agent, such as derivatives of hydrophobic molecules, for example Incroslip™ or Incromol™ from Croda.

The heat-shrinkable film comprising the semicrystalline thermoplastic polyester may also undergo additional treatment steps which make it possible to improve its properties, before being used for the covering step c).

By way of example of additional treatments, mention will for example be made of corona treatment, metallization treatment or alternatively plasma treatment.

The corona treatment makes it possible, via ionization of the air by means of a high-frequency and high-voltage electric arc, to create microporosities on the surface of the heat-shrinkable film, enabling in particular inks and adhesives to adhere better. Thus treated, the heat-shrinkable films have a most particular application for packaging.

The metallization treatment makes it possible, via vacuum evaporation of aluminum, to condense a layer of aluminum of a few nanometers to a few tens of nanometers at the surface of the heat-shrinkable film which is then cooled to prevent melting of said film. This treatment makes it possible to opacify the heat-shrinkable film and thus to limit the penetration of light, which is particularly advantageous for avoiding degrading the properties of any content.

Finally, plasma treatment consists in using the atmospheric plasma deposition technology in order to treat the outermost surface (a few nm) of the heat-shrinkable film and enable selective grafting of chemical functions to be carried out. This selective grafting may thus provide the heat-shrinkable film with a non-stick or adhesion-promoting effect.

The use according to the present invention of semicrystalline thermoplastic polyester for the preparation of heat-shrinkable films is particularly advantageous.

Indeed, the heat-shrinkable films thus prepared from semicrystalline thermoplastic polyester of which the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) is at least 0.05 and at most 0.30, and the reduced solution viscosity of which is greater than 50 ml/g as described above, have noteworthy properties, both from the point of view of the mechanical properties and of the optical quality and also in terms of gas permeability.

Indeed, the heat-shrinkable films prepared exhibit improved heat resistance which results in an increase in the drawing rate of the assemblies for the complexed heat-shrinkable films and also in a greater temperature use range than the usual heat-shrinkable films obtained with PET.

The heat-shrinkable films prepared also exhibit improved mechanical properties such as the tensile modulus, the yield strength and the tear strength. These improvements make it possible to offer solutions that are stronger for primary, secondary and tertiary packaging.

The packaging process according to the invention then comprises a step c) of covering by means of the heat-shrinkable film prepared in the preceding step b).

This covering step can be carried out on all or part of the product to be packaged and can in particular be a primary, secondary or tertiary packaging step.

The primary packaging constitutes a material envelope in direct contact with the product, which is also referred to as the wrapping. Examples of primary packagings are in particular sachets, bags, or else covers in film form of certain food containers.

Next, the secondary packaging surrounds the wrapping and plays a physical role making it possible in particular to facilitate the conveying to the sales shelves or else to constitute larger sales units. This is the level of packaging with which the consumer is confronted when making his or her choice in the shop. This level of packaging makes it possible, for example, to group the sales units together by means of a heat-shrinkable film. The heat-shrinkable film thus used may for example be in the form of a band or a ribbon which can in particular be transparent so that the product can be seen or can exhibit a combination of colors intended to attract the consumer.

Finally, the tertiary packaging groups the products together for example into delivery units and thus makes it possible to facilitate and accelerate the handling operations or to protect the product during storage.

After the covering step, the packaging process according to the invention comprises a heat treatment step.

This heat treatment step can also be carried out by the methods known to those skilled in the art which are conventionally implemented for shrinking films. Thus, those skilled in the art will easily know what heat treatment must be applied depending on the packaging to be obtained (primary, secondary or tertiary).

Thus, by way of example, the heat treatment can consist in applying a fluid such as a gas or a solution to the heat-shrinkable film, said fluid being at a sufficient temperature enabling the film to shrink while the same time remaining, however, below the melting point of said film. Preferentially when it is a question of a primary or secondary packaging, the heat treatment is carried out by applying a solution and in particular a glycerol solution. The heat treatment is carried out by dipping in a hot solution.

Advantageously, and in order to obtain the best degree of shrinkage, the temperature of the heat treatment is equal to the temperature which the heat-shrinkable film had at the time when the stresses imparted during production were fixed by cooling.

The application of a heat treatment according to the invention makes it possible to obtain a degree of shrinkage of the films of between 40% and 90%, particularly between 65% and 85%, even more particularly between 70% and 80%, such as for example 75%.

The degree of shrinkage can be measured according to the following steps:
cutting the film into squares 10 cm×10 cm in size,
measuring the dimensions for verification,
depositing the sample in a glycerol bath at 140° C. for 30 seconds,
measuring the dimensions on leaving the glycerol bath and comparing with the measurements obtained before the depositing step.

The degree of shrinkage can thus be defined as the decrease in width of a square of film when said film is brought to the shrinkage temperature, said decrease being expressed as percentage of the initial dimension of the square.
A second subject of the invention relates to a packaging obtained from a heat-shrinkable film produced from the semicrystalline thermoplastic polyester as defined above. The heat-shrinkable film according to the invention may also comprise an additional polymer and/or one or more additives as defined above.

The semicrystalline thermoplastic polyester supplied in step a) of the packaging process according to the invention may be prepared by a synthesis process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing, into the reactor, a catalytic system;
a step of polymerizing said monomers to form the polyester, said step consisting of:
   a first stage of oligomerization, during which the reaction medium is stirred under an inert atmosphere at a temperature ranging from 265 to 280° C., advantageously from 270 to 280° C., for example 275° C.;
   a second stage of condensation of the oligomers, during which the oligomers formed are stirred under vacuum, at a temperature ranging from 278 to 300° C. so as to form the polyester, advantageously from 280 to 290° C., for example 285° C.;
a step of recovering the semicrystalline thermoplastic polyester.

This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease gradients, in steps, or else using a combination of pressure decrease gradients and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting in the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer in accordance with the use according to the invention for the production of heat-shrinkable films.

An esterification catalyst is advantageously used during the oligomerization stage. This esterification catalyst can be chosen from derivatives of tin, titanium, zirconium, hafnium, zinc, manganese, calcium and strontium, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

Finally, the process comprises a step of recovering the polyester upon completion of the polymerization step. The semicrystalline thermoplastic polyester thus recovered can then be formed as described above.

According to one variant of the synthesis process, a step of increasing the molar mass is carried out after the step of recovering the semicrystalline thermoplastic polyester.

The step of increasing the molar mass is carried out by post-polymerization and may consist of a step of solid-state polycondensation (SSP) of the semicrystalline thermoplastic polyester or of a step of reactive extrusion of the semicrystalline thermoplastic polyester in the presence of at least one chain extender.

Thus, according to a first variant of the production process, the post-polymerization step is carried out by SSP.

SSP is generally carried out at a temperature between the glass transition temperature and the melting point of the polymer. Thus, in order to carry out the SSP, it is necessary for the polymer to be semicrystalline. Preferably the latter has a heat of fusion of greater than 10 J/g, preferably greater than 20 J/g, the measurement of this heat of fusion consisting in subjecting a sample of this polymer of lower reduced solution viscosity to a heat treatment at 170° C. for 16 hours, then in evaluating the heat of fusion by DSC by heating the sample at 10 K/min.

Advantageously, the SSP step is carried out at a temperature ranging from 190 to 280° C., preferably ranging from 200 to 250° C., this step imperatively having to be carried out at a temperature below the melting point of the semicrystalline thermoplastic polyester.

The SSP step may be carried out in an inert atmosphere, for example under nitrogen or under argon or under vacuum.

According to a second variant of the production process, the post-polymerization step is carried out by reactive extrusion of the semicrystalline thermoplastic polyester in the presence of at least one chain extender.

The chain extender is a compound comprising two functions capable of reacting, in reactive extrusion, with alcohol, carboxylic acid and/or carboxylic acid ester functions of the semicrystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in any of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semicrystalline thermoplastic polyester obtained in the extrusion step.

During the extrusion, the temperature inside the extruder is adjusted so as to be above the melting point of the polymer. The temperature inside the extruder may range from 150° C. to 320° C.

The semicrystalline thermoplastic polyester obtained after the step of increasing the molar mass is recovered and may then be formed as previously described, before undergoing the step of preparing heat-shrinkable film.

The invention will be understood more clearly by means of the examples and figures below, which are intended to be purely illustrative and do not in any way limit the scope of the protection.

### EXAMPLE

The properties of the polymers were studied via the following techniques:

Reduced Solution Viscosity

The reduced solution viscosity is evaluated using an Ubbelohde capillary viscometer at 25° C. in an equi-mass mixture of phenol and ortho-dichlorobenzene after dissolving the polymer at 130° C. with stirring, the concentration of the polymer introduced being 5 g/I.

DSC

The thermal properties of the polyesters were measured by differential scanning calorimetry (DSC): The sample is first heated under a nitrogen atmosphere in an open crucible from 10° C. to 320° C. (10° C.·min⁻¹), cooled to 10° C. (10° C.·min⁻¹), then heated again to 320° C. under the same conditions as the first step. The glass transition temperatures were taken at the mid-point of the second heating. Any melting points are determined on the endothermic peak (peak onset) at the first heating.

Similarly, the enthalpy of fusion (area under the curve) is determined at the first heating.

For the illustrative examples presented below, the following reagents were used:

1,4-Cyclohexanedimethanol (99% purity, mixture of cis and trans isomers)

Isosorbide (purity >99.5%) Polysorb® P from Roquette Freres

Terephthalic acid (99+% purity) from Acros

Irganox® 1010 from BASF AG

Dibutyltin oxide (98% purity) from Sigma-Aldrich

Supplying of a Semicrystalline Thermoplastic Polyester and Preparation of a Heat-Shrinkable Film for Packaging

Two thermoplastic polyesters P1 and P2 were prepared.

The first semicrystalline thermoplastic polyester P1 was prepared for use according to the invention with in particular a molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and at most 0.30.

The second polyester P2 is a polyester which serves as a comparison and thus has an [A]/([A]+[B1) molar ratio of 0.44.

A: Polymerization of the Semicrystalline Thermoplastic Polyester P1

Thus, 1432 g (9.9 mol) of 1,4-cyclohexanedimethanol, 484 g (3.3 mol) of isosorbide, 2000 g (12.0 mol) of terephthalic acid, 1.65 g of Irganox 1010 (antioxidant) and 1.39 g of dibutyltin oxide (catalyst) are added to a 7.5 I reactor. To extract the residual oxygen from the isosorbide crystals, four vacuum-nitrogen cycles are performed once the temperature of the reaction medium is between 60° C. and 80° C. The reaction mixture is then heated to 275° C. (4° C./min) under 6.6 bar of pressure and with constant stirring (150 rpm) until a degree of esterification of 87% is obtained. (Estimated on the basis of the mass of distillate collected). The pressure is then reduced to 0.7 mbar over the course of 90 minutes according to a logarithmic gradient and the temperature is brought to 285° C.

These vacuum and temperature conditions were maintained until an increase in torque of 12.1 Nm relative to the initial torque is obtained.

Finally, a polymer rod is cast via the bottom valve of the reactor, cooled in a heat-regulated water bath at 15° C. and chopped up in the form of granules of about 15 mg.

The resin thus obtained has a reduced solution viscosity of 80.1 ml/g⁻¹.

The ¹H NMR analysis of the polyester shows that the final polyester contains 17 mol % of isosorbide relative to the diols.

With regard to the thermal properties, the polymer has a glass transition temperature of 96° C., a melting point of 253° C. with an enthalpy of fusion of 23.2 J/g.

The granules are then used in a solid-state post-condensation step.

For this purpose, the granules are crystallized beforehand for 2 h in an oven under vacuum at 170° C.

The solid-state post-condensation step is then carried out on 10 kg of these granules for 20 h at 210° C. under a stream of nitrogen (1500 I/h) in order to increase the molar mass. The resin after solid-state condensation has a reduced solution viscosity of 103.4 ml·g.

A′: Polymerization of the Thermoplastic Polyester P2

The polyester P2 was prepared according to the same protocol as P1 with the exception of the solid-state post-condensation step.

The compound amounts used are given in detail in table 1 below:

| | | P2 |
|---|---|---|
| COMPOUNDS | 1,4-cyclohexanedimethanol | 859 g (6 mol) |
| | Isosorbide | 871 g (6 mol) |
| | Terephthalic acid | 1800 g (10.8 mol) |
| | Irganox 1010 (antioxidant) | 1.5 g |
| | Dibutyltin oxide (catalyst) | 1.23 g |

The resin thus obtained with the polyester P2 has a reduced solution viscosity of 54.9 ml/g.

The ¹H NMR analysis of the polyester shows that the final polyester P2 contains 44 mol % of isosorbide relative to the diols. With regard to the thermal properties, the polyester P2 has a glass transition temperature of 125° C., and does not exhibit an endothermic fusion peak in differential scanning calorimetry analysis, even after heat treatment for 16 h at 170° C., thereby indicating its amorphous nature.

B: Forming

The granules of the polyesters P1 and P2 obtained in the polymerization steps A and A′ are vacuum-dried at 150° C. for P1 and 110° C. for P2 in order to achieve residual moisture contents of less than 300 ppm; in this example, the water content of the granules is 130 ppm for the polyester P1 and 170 ppm for the polyester P2.

The granules, kept in a dry atmosphere, are then introduced into the hopper of the extruder.

The extruder used is a Collin extruder fitted with a flat die, the assembly being completed by a calendering machine. The extrusion parameters are collated in table 2 below:

| Parameters | Units | Values |
|---|---|---|
| Temperature (feed -> die) | ° C. | 250/265/275/275/280 (P1) |
| | | 220/235/245/245/250 (P2) |
| Screw rotation speed | rpm | 80 |
| Temperature of the rollers | ° C. | 40 |

The sheets thus extruded from the polyesters P1 and P2 have a thickness of 2 mm.

The sheets are then cut up into squares 11.5×11.5 cm in size and then, using a Bruckner Karo IV stretching machine, the cut pieces of the sheets are stretched in two directions, this being carried out at a temperature of 140° C. with a stretch ratio of 2.8×2.8 and for a time of 2 seconds in the two directions. A biaxially oriented heat-shrinkable film is thus obtained.

C: Heat Treatment

Squares 10×10 cm in size are cut from the films obtained in the preceding forming step and immersed in a glycerol bath for 30 seconds at 140° C.

The films obtained from the semicrystalline thermoplastic polyester P1 exhibit a degree of shrinkage of 75%, whereas the film obtained from the comparative polyester P2 does not shrink.

Thus, the films produced from semicrystalline thermoplastic polyester, with in particular a molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and of at most 0.30 according to the invention, have particularly advantageous shrinkage properties and are termed heat-shrinkable.

The heat-shrinkable films produced according to the invention thus have a most particular application in the packaging field.

1. A method for packaging products using heat-shrinkable film produced from the semicrystalline thermoplastic polyester, comprising the following steps:
a) providing a semicrystalline thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] molar ratio is at least 0.05 and at most 0.30, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 50 ml/g;
b) preparing a heat-shrinkable film from the semicrystalline thermoplastic polyester obtained in step a),
c) covering a product by means of the heat-shrinkable film obtained in step b), and
d) applying a heat treatment to said packaged product.

2. The method according to claim 1, wherein the preparation step b) is carried out by the cast extrusion method, and in particular by the Stenter process.

3. The method according to claim 1, wherein that it comprises, before the covering step c), a step of additional treatment of the heat-shrinkable film prepared in step b).

4. The method according to claim 3, wherein the additional treatment is a corona treatment, a metallization treatment or a plasma treatment.

5. The method according to claim 1, wherein the step d) of applying a heat treatment is carried out by dipping in a hot solution.

6. The method according to claim 1, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

7. The method according to claim 1, wherein the 1,4:3,6-dianhydrohexitol (A) is isosorbide.

8. The method according to claim 1, wherein the polyester does not contain any aliphatic non-cyclic diol units, or comprises a molar amount of aliphatic non-cyclic diol units, relative to all the monomer units of the polyester, of less than 1%.

9. The method according to claim 1, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

10. The method according to claim 1, wherein the heat-shrinkable film has a thickness of from 10 μm to 250 μm.

11. The method according to claim 1, wherein the heat-shrinkable film comprises one or more additional polymers and/or one or more additives.

12. A packaging, comprising a heat-shrinkable film produced from the semicrystalline thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] molar ratio is at least 0.05 and at most 0.30, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 50 ml/g.
